(19) United States
(12) Patent Application Publication
(10) Pub. No.: US 2024/0113909 A1
(43) Pub. Date: Apr. 4, 2024

(54) System and Method for Monitoring Room Disturbances

(71) Applicants: JOSHUA ROGERS, Los Angeles, CA (US); GARETH RHODES, Los Angeles, CA (US); Irimia Suleapa, Los Angeles, CA (US)

(72) Inventors: JOSHUA ROGERS, Los Angeles, CA (US); GARETH RHODES, Los Angeles, CA (US); Irimia Suleapa, Los Angeles, CA (US)

(21) Appl. No.: 17/959,739

(22) Filed: Oct. 4, 2022

(51) Int. Cl. H04L 12/28; H04M 1/72421; H04M 1/72436

(52) U.S. Cl. CPC H04L 12/2825; H04M 1/72421; H04M 1/72436; G16Y 20/10

(57) ABSTRACT

A system and method for discretely monitoring rooms for disturbances and environmental conditions is disclosed. The system is comprised of a room sensor device, a cloud network and a website dashboard. Said room sensor device can be plugged into a conventional outlet and detects conditions that include noise levels, carbon monoxide & dioxide levels, temperature, humidity, the presence of smoke and other particles and occupancy in real time (together these are considered a ‘disturbance event’). Should any sensor preset thresholds be met or exceeded, the user is notified by means of a text message, email, or other electronic means automatically and in real time so they can take appropriate action. An object of the device is to provide a smart room monitoring sensory system for homeowners, property managers and hoteliers to minimize disturbances and enhance occupant experiences.

### FIELD OF THE INVENTION

The present invention generally relates to monitoring systems. More specifically, it relates to a system that allows homeowners, property managers, hoteliers and others to monitor room conditions discretely and in real time.

### BACKGROUND

Smart home technology provides building owners with many advantages including enhanced security, comfort, energy efficiency and convenience. The phrase ‘smart home’ or ‘home automation’ is used to describe an internal space that has lighting, appliances, heating, TVs, air conditioning, entertainment audio and video systems, computers, cameras and security systems that can communicate with one another and be remotely controlled from any room in the home, as well as remotely from any location via a smartphone or the internet. As communication and internet of things (IOT) technologies become more popular, owners are becoming more aware of the capability of smart home technologies, as they continue to automate their homes. The first smart home systems were believed to have been introduced in the 1960s with the invention of the ‘Echo IV.’ This device allowed consumers to create computing shopping lists, control the temperature of the home and turn appliances on and off. Created in 1969, the kitchen computer could even generate recipes. However, the device never became a commercial success due to its high price. The development of the microcontroller in 1971 resulted in price reductions for electronics devices, making the technologies more accessible. In 1991, a concept called ‘gerontechnology’ was introduced, which combined gerontology with technology aimed at making the lives of senior citizens easier. Several new technologies were introduced in this sector during the 1990s. The early 2000s were marked by the rapid increase in the popularity of smart home technology. Different wireless technologies emerged and were slowly integrated in the homes. Smart homes started to become affordable for many consumers. Home networking, personal assistants and various other consumer gadgets became available. Smart home automation is now ubiquitous in the current market and building owners and homeowners are now able to control the heating, TVs, lights, doors and alarms via remote controllers and smartphones.

As IOT continues to evolve in the smart home market, hotel managers and apartment managers have started looking at ways to monitor their indoor spaces to ensure minimal disruptions and improve the quality of life for all of its occupants. European Patent no. EP0341022A2 granted to Ran Kenet discloses a room monitor that includes temperature sensing and occupant sensing; however, it does not incorporate sound monitoring. U.S. Pat. No. 9,959,737 granted to Andrew Schulz and David Krauss teaches of a sound detection apparatus for rental apartments; however, it does not appear to be part of an overall web-based monitoring system. International Patent No. WO2015153786A1 was granted to disclose a disturbance system that includes monitoring room conditions; however, the data gathering system is more focused on predictive analytics. What is needed is a disturbance detection system geared toward building managers and hotel owners that is simple to deploy and operate.

### SUMMARY OF THE INVENTION

The device herein disclosed and described provides a solution to the shortcomings in the prior art through the disclosure of a system and method for disturbance detection in rooms. An object of the invention is to minimize room problems to maximize a quality experience for occupants. For example, a hotel has a strict noise policy at their establishment and noise levels must be kept to a minimum after a specific hour in the evening. The system has a noise sensor that detects sound in decibels. If loud noises are generated over a preset threshold after a specified time period in a room after hours, the system will trigger an alert, notifying staff of a violation that is taking place.

Another object of the invention is to notify stakeholders of a disturbance. For example, a bed and breakfast has a strict, non-smoking policy. If cigarette smoke is detected in one of the rooms the system automatically sends a text, email or other digital reminder to the occupant's (mobile) device that smoking on the property is not allowed. The system also sends a text message and email to managers or other designated users alerting them of the situation.

Another object of the invention is to monitor for potential fire by measuring levels of carbon dioxide (CO2) and carbon monoxide (CO) with sensors. For example, if carbon dioxide levels exceed a preset threshold, the system understands that a fire could be extracting oxygen and generate CO and can automatically send a text, email or other digital notification to the occupant or any contacts specified by the operator.

Another object of the invention is to monitor overall, general air quality of rooms and homes for occupant comfort. The invention combines data from CO, CO2 and particle sensors to determine indoor air quality. For example, if CO2 levels and PM 2.5 (particulate matter) levels are elevated, the system can inform users of the findings so that they may take appropriate steps to improve air quality within said room (such as to restrict smoking, increase heating, venting, and air conditioning levels etc.).

Another object of the invention is to maintain proper room occupancy. For example, a college dormitory has specific occupant restrictions to maintain compliance with fire codes. The sensor device has the ability to detect Bluetooth activity (pairing frequencies) and extrapolate from these how many devices are in the vicinity to determine occupancy. The device also has the ability to detect nearby Wi-Fi activity (number and signal strength) in order to estimate how many devices are in the vicinity over extended periods to determine occupancy. If sensors detect a gathering that is too large in a common area it will detect an over-crowded condition and notify the residential assistant.

Another object of the invention is to allow users to monitor their rooms in real time. The system includes a web-based dashboard that displays readings from all sensors at any time as well as historical data records of any threshold breaches that may have occurred. This historical data from a user dashboard can relate to any specific event or combination of events. For example, a hotel may receive a chargeback for a smoking deposit paid by a previous guest. The hotel can download records of violations that took place during the guests' stay to submit as evidence in a chargeback dispute with the guests' credit card company.

Another object of the invention is to allow users to perform sensor management allowing users to determine which sensors will be used in the device and set custom time-based schedules. For example, a manager may wish to monitor only sound and smoke in one room and only smoke in a hallway. The device settings can be remotely modified by the user to enable or disable certain sensors remotely from the user dashboard. In the same example, a hotel manager may wish to disable noise monitoring during standard cleaning hours, when noise may be considerably higher due to vacuum cleaning.

Another object of the invention is to provide an onboard power plug that provides electrical power and also allows the device to be installed along a wall or ceiling.

Another object of the invention is to allow users to establish pre-set sensor thresholds for each sensor on the device. For example, a user can set the sound sensor to generate an alert if noise reaches over 65 decibels and they can set maximum occupancy at two individuals per room etc.

It is briefly noted that upon reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention in use.

FIG. 2 shows major operations of the system and how it is interconnected.

FIG. 3 shows various views of the device.

FIG. 4 shows the method of the system.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

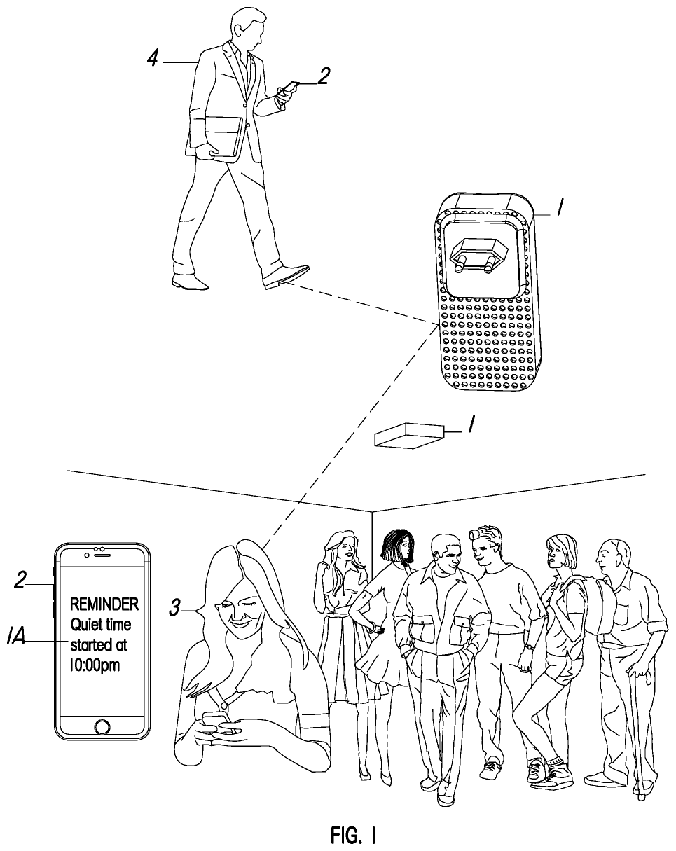

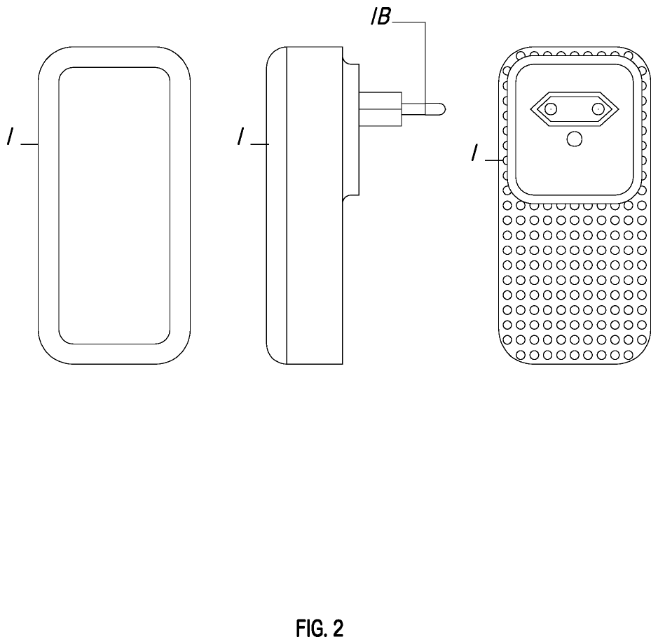

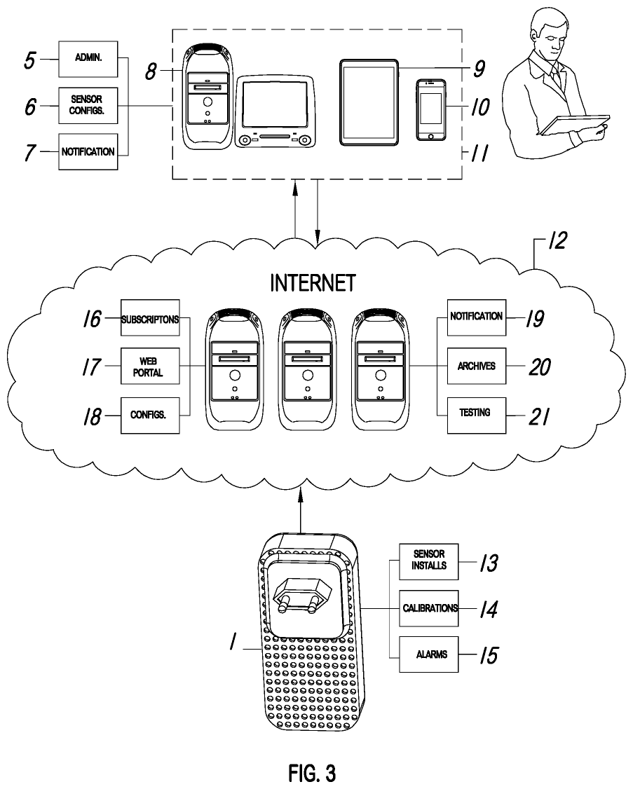

FIG. 1 shows a preferred embodiment of the room sensor device in a crowded hotel room making too much noise after hours. The room sensor device 1 installed on a ceiling electrical outlet and detecting noise in the room that is above a preset threshold, sending a wireless signal to the cloud network that sends an alert 1A to both the occupant 3's cell phone and hotel manager 4's mobile device 2 using the system's proprietary software. The cloud network also having servers for processing and storing data and supporting a web site with dashboard for users allowing them to track historical records and define preset sensor thresholds individually or in groups. The software residing on a non-transitory computer readable medium including computer readable instructions that, when executed by a computer, cause the computer to perform operations such as but not limited to: receiving, sending and storing sensor data and notifying users of any preset sensor threshold breaches and the like. The software can operate as a mobile device application or a desktop application. FIG. 2 showing the device comprised of a square case with power prongs 3B thereon. FIG. 3 showing said room sensor device 1 being comprised of a case with a micro controller (such as but not limited to Arduino, raspberry pi and the like) with WiFI transmitter and a plurality of interchangeable sensors such as but not limited to: temperature, humidity, presence of smoke, particle counter, noise levels, and thermal imager and the like. Room occupancy is determined by a Bluetooth frequency sensor that measures mobile device frequencies and feeds them to an algorithm that tabulates occupancy in a room. Room sensor device 1 also having a 120 volt, A.C. power connection allowing it to be plugged into a conventional room outlet as well as an onboard backup battery backup (including but not limited to lithium ion etc.), encrypted flash memory storage, ethernet cable port. The room sensor device 1 having its own IP address and wirelessly-connecting with a multitude of WiFi routers. Other embodiments of the room sensor device can incorporate artificial intelligence algorithms into the software that learn to predict an actual problem event based on correlating multiple sensor data results in order to enhance overall event detection accuracy.

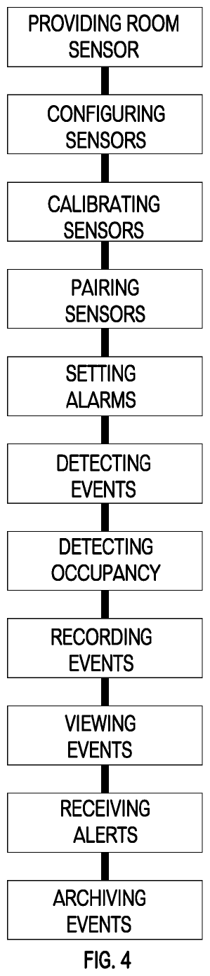

FIG. 4 showing the logistics operations with users having access to functions such as but not limited to administrative functions 5 (account registration, contact information, subscription payments, notification preferences etc.); sensor configuration 6 (setting sensor installation type, remote calibrations), pairing the various devices up to the cloud network 12, configuring sensor operating schedules and locations (when to power on, how long to remain active, when to engage local area networks and transmit data etc.); and notification settings 7 (based on threshold settings etc.). The user establishes a set of thresholds that they consider an event that disturbs others inside the building—defined as a ‘disturbance event.’ The software is also compatible with a plurality of operating systems such as, but not limited to: Windows Apple and Android and compatible with a multitude of hardware platforms 11 including, but not limited to: personal desktops 8, laptops, tablets 9, smartphones 10 and the like. The figure showing room sensor 1 having functions such as but not limited allowing user to install a plurality of the aforementioned sensors; receiving user calibration settings 14 (can also be performed locally); and alarm settings 15 according to user presets (time off/on, durations, alert thresholds etc.). FIG. 3 also showing users and controllers connected by means of cloud network 12. Said cloud network 12 having algorithms and routine operations such as but not limited to: subscription services 16 (user demographics, sensor registrations, online payments etc.); web portal operations 17 (website backend management, API, user interface etc.); selective parameter configurations 18 (power on time, dormant mode, time presets, transmission schedules, transmission rates etc.); notifications 19 (emergency alerts, dynamic shipping alerts etc. via text messages SMS, email, Api and webhooks and the like); archives 20 on the cloud network (event data recordings and storage libraries etc.); and testing 21 (remote sensor tests etc.).

FIG. 5 shows the method of the device which includes the following steps: providing a room with a device (installing it on a ceiling etc. and establishing a power source and a wireless connection—may be to a local area network etc.); users configuring sensor operating parameters (when to power on, how long to remain active, threshold levels to send alerts); calibrating sensors (testing, replacements etc.); pairing sensors with cloud network via local area networks and routers etc.; setting alarm settings (assigning thresholds, response alerts and notifications); detecting an event (environmental sensor breaching a threshold); determinging occupancy (Bluetooth signals recorded and occupancy of room extrapolated by device count); recording an event with sensor data being transmitted across local area network and received by cloud network account; users viewing recorded events on their mobile devices and computers using software app and website; users receiving emergency alerts when a sensor threshold is breached by means of SMS, text, email and the like; and archiving event recordings on the cloud network which is encrypted and available to users.

Those of skill in the art will recognize that mobile applications are written in several languages include, by way of non-limiting examples, C, C++, C #, Objective-C, Java, Javascript, Pascal, Object Pascal, Python, Ruby, VB.NET, WML, and XHL/HL with or without CSS, or combinations thereof. The app in invention 1 is also compatible with a plurality of operating systems such as, but not limited to: Windows, Apple, and Android, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK. Those of skill in the art will recognize that several commercial forums are available for distribution of mobile applications including, by way of non-limiting examples, Apple App Store, Google Play, Chrome Web Store, BlackBerry App World, App Store for Palm devices, App Catalog for webOS, Windows Marketplace for Mobile, Ovi Store for Nokia devices, Samsung Apps, and Nintendo DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe Flash Player, Microsoft Silverlight, and Apple QuickTime.

In view of the disclosure provided herein, those of skill in the art will recognize that several plug-in frameworks are available that enable development of plug-ins in various programming languages, including, by way of non-limiting examples, C++, Delphi, Java™ PHP, Python, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer, Mozilla Firefox, Google Chrome, Apple Safari, Opera Software Opera, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry Browser, Apple Safari, Palm Blazer, Palm WebOS Browser, Mozilla Firefox for mobile, Microsoft Internet Explorer Mobile, Amazon Kindle Basic Web, Nokia Browser, Opera Software Opera Mobile, and Sony PSP™ browser. Software Modules.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A device for monitoring room disturbances and environmental conditions comprised of the following parts:
a) a case;
b) a microcontroller;
c) interchangeable sensors;
d) an onboard battery backup;
e) a power plug;
f) software; and
g) a cloud network.

2. The device for monitoring room disturbances and environmental conditions of claim 1, wherein the interchangeable sensors being comprised of temperature, gasses, humidity, smoke, particles, carbon dioxide, carbon monoxide, a microphone, thermal imaging, Wi-Fi receiver and Bluetooth receiver.

3. The device for monitoring room disturbances and environmental conditions of claim 1, wherein the micro controller having encrypted flash memory storage and a Wi-Fi transmitter.

4. The device for monitoring room disturbances and environmental conditions of claim 1, wherein the software resides on a non-transitory computer readable medium including computer readable instructions that, when executed by a computer, cause the computer to perform operations that include setting preset sensor thresholds, preset sensor activities individually or in groups administrative functions, sensor configurations, paring devices, configuring sensor schedules and locations, notifications, and alarm thresholds.

5. The device for monitoring room disturbances and environmental conditions of claim 1, wherein the software can operate as a mobile device application or a desktop application with algorithms that include room occupancy determinations and sensor management.

6. The device for monitoring room disturbances and environmental conditions of claim 1, wherein the cloud network having servers for processing and storing data and supporting a website with a dashboard for users.

7. A method for monitoring room disturbances and environmental conditions comprising the following steps:
a) providing the device of claim 1;
b) configuring sensor operating parameters using the software;
c) calibrating sensors using the software;
d) pairing sensors with the cloud network;
e) setting notification settings using the software;
f) detecting disturbance events with the sensors;
g) detecting occupancy with the Bluetooth frequency sensor and Wi-Fi module;
h) recording disturbance events to the cloud network;
i) viewing recorded disturbance events on the software;
j) receiving emergency alerts sent by the software; and
k) archiving event recordings on the cloud network.

8. The method for monitoring room disturbances and environmental conditions of claim 7, wherein the configuring sensor operating parameters includes the step of determining when to power on and how long to remain active.

9. The method for monitoring room disturbances and environmental conditions of claim 7, wherein the setting alarm settings includes the step of establishing time on and off, durations, and thresholds.

10. The method for monitoring room disturbances and environmental conditions of claim 7, wherein the receiving emergency alerts includes the step of the software sending alerts to users in the form of SMS, texts, and emails.
